(19) United States
(12) Patent Application Publication
(10) Pub. No.: US 2018/0300754 A1
(43) Pub. Date: Oct. 18, 2018

(54) METHODS AND SYSTEMS FOR PERFORMING AN ADVERTISEMENT BASED ELECTRONIC TRANSACTION USING A MOBILE DEVICE

(71) Applicant: Omnyway, Inc., Redwood City, CA (US)

(72) Inventors: Ashok Narasimhan, San Francisco, CA (US); Mohammad Khan, San Jose, CA (US); William N. Melton, San Francisco, CA (US)

(21) Appl. No.: 16/014,992

(22) Filed: Jun. 21, 2018

Related U.S. Application Data
(63) Continuation of application No. 15/763,811.
(60) Provisional application No. 62/233,427, filed on Sep. 27, 2015.

(51) Int. Cl. G06Q 30/02; G06Q 20/32; G06F 21/32

(52) U.S. Cl. CPC G06Q 30/0253; G06Q 30/0269; G06F 21/32; G06Q 20/3278; G06Q 20/3224; G06Q 20/3276

(57) ABSTRACT

Methods and systems for performing an advertisement-based electronic transaction using a mobile device are provided herein. According to one aspect, the subject matter described herein comprises a system for performing an advertisement-based electronic transaction using a mobile device. The system comprises a database for storing and maintaining payment information for mobile users and a mobile backend server that receives, from a mobile device of a user, first information about an item or transaction, wherein the mobile device received the first information from an advertisement available to the mobile device, and second information about the user, that processes the first and second information to determine transaction information and to generate payment information, and that sends the transaction and payment information to a payment network for processing the ecommerce transaction.

This application is a continuation of U.S. patent application Ser. No. 15/763,811, filed Mar. 27, 2018, which is a 35 U.S.C. § 371 national phase filing of International Application No. PCT/US2016/054028, filed Sep. 27, 2016, which claims the benefit of U.S. Provisional Application No. 62/233,427, filed Sep. 27, 2015, the disclosures of which are incorporated herein by reference in their entireties.

### TECHNICAL FIELD

This disclosure relates to performing secure financial and non-financial electronic transactions made by consumers. More specifically, it relates to methods and systems for performing an advertisement-based electronic transaction, such as an ecommerce transaction, using a mobile device.

### BACKGROUND

Electronic payments, ecommerce transactions, and the like, have evolved from requiring a physical credit card with information encoded on a magnetic stripe that must be “swiped” at a physical card reader (a so-called “card present” or “CP” transaction), to the use of the credit card information (card number, cardholder name, etc.) on ecommerce sites, for example (a so-called “card not present” or “CNP” transaction). Both of these conventional types of transactions, however, rely on the use or presence of merchant equipment, such as a Point Of Sale (POS) terminal in the case of the CP transaction and an ecommerce website in the case of a CNP transaction. The ultimate destination for the transaction information is typically an electronic payment network, such as the Visa™ payment network, that acts as the mechanism by which funds are transferred from the buyer to the seller of an electronic transaction, for example.

With the advent and ubiquity of smart phones, however, an opportunity has arisen to use the inherent network capabilities of a smart phone or other mobile device to engage in transactions that ultimately end up as an electronic transaction performed on an electronic payment network, but without the overhead of POS terminals or ecommerce websites. Having the ability to engage in purchases of goods and services or other types of commerce transaction free from these conventional encumbrances would create an entirely new type of sales channel that can drive consumer impulse buying with a minimum of resistance.

Being able to perform an ecommerce transaction using only an application on a mobile phone without the traditional infrastructure of POS terminals or ecommerce websites makes possible the ability to perform ecommerce transactions potentially anywhere. The user need only be able to identify the desired goods or services unambiguously using his or her mobile device; the rest of the process can take place in the background via secure channels. This technique is well suited for endowing internet ads, pop-up ads, pop-under ads, and other types of advertisements with the ability to effect an ecommerce or other type of electronic transaction simply by displaying a QR code, a bar code, or any other type of visual, aural, or even haptic information within the advertisement, which the ad viewer scans or otherwise captures with a mobile device, thus triggering the transaction, which is processed by a backend server, for example.

Such a transaction is referred to herein as an “advertisement-based electronic transaction”. Such transactions may be ecommerce transactions or other financial transactions, but may also be non-financial transactions. Financial transactions may be card not present transactions or card present transactions. Here, the term “advertisement” is used in its broadest meaning, i.e., to refer to any means by which a merchant or seller can advertise or make public the fact that goods or services are available for purchase, etc.

Accordingly, there is a need for methods and systems for performing an advertisement-based electronic transaction using a mobile device.

### SUMMARY

The subject matter disclosed herein comprises methods and systems for performing an advertisement-based electronic transaction using a mobile device.

According to one aspect, the subject matter described herein comprises a system for performing an advertisement-based electronic transaction using a mobile device. The system comprises a database for storing and maintaining payment information for mobile users, and a mobile backend server that receives, from a mobile device of a user, first information about an item or transaction, wherein the mobile device received the first information from an advertisement available to the mobile device, and second information about the user, that processes the first and second information to determine transaction information and to generate payment information, and that sends the transaction and payment information to a payment network for processing the ecommerce transaction.

In one embodiment, receiving the first information comprises scanning, by the mobile device, text or an image that contains the first information in encoded form and decoding the text or image to extract the first information.

In one embodiment, receiving the first information comprises receiving the first information via an email, via a text message, via a multimedia message, or via an application hosted by the mobile device.

In one embodiment, receiving the first information comprises selecting text or an image being displayed on the mobile device, the text or image containing the first information in encoded form, and decoding the text or image to extract the first information.

In one embodiment, receiving the first information comprises selecting, by a computing device other than the mobile device, text or an image being displayed on the computer device other than the mobile device, the text or image containing the first information in encoded form, and decoding the text or image to extract the first information.

In one embodiment, the text or image comprises a QR code image or bar code image.

In one embodiment, the text or image comprises a text image and wherein decoding the image comprises performing optical character recognition on the text image to extract the first information.

In one embodiment, the text or image comprises an image that contains information that is encoded steganographically within the image.

As used herein, the term “encoded steganographically” refers to the encoding of data within an image (which may also be an image of text) in such a way that the presence of the data within the image is not obvious. An example of steganographic encoding includes manipulating an image such that the least significant bit value of each pixel within the image, when aggregated into a string of bits, reconstruct the data being hidden within the image.

In one embodiment, receiving the first information comprises receiving or recording an audio sample that is presented or played from an advertisement and that contains the first information encoded as sound and decoding the audio sample to extract the first information.

In one embodiment, receiving the first information comprises receiving the first information via a wireless signal through a wireless interaction with a device that makes the advertisement available to the mobile device.

In one embodiment, receiving the first information via a wireless signal through a wireless interaction with the device that makes the advertisement available to the mobile device comprises at least one of: communicating using a near field communication (NFC) protocol; communicating using a radio frequency (RF) protocol; receiving the first information from a radio frequency identifier (RFID) chip; and communicating using an infrared (IR) communication protocol.

Examples of RF protocols include, but are not limited to, wireless, including cellular, Wi-Fi, and Wi-MAX, Bluetooth™, Bluetooth Low Energy (BLE)™, and others.

In one embodiment, the first information comprises at least one of: information that directly identifies the item or transaction; information that indirectly identifies the item or transaction; and information that indicates a source from which information about the item or transaction may be received.

In one embodiment, sending second information about the user comprises sending at least one of: information that identifies the user; information that identifies the mobile device; a current location of the user or mobile device; a billing address of the user; a shipping address of the user; a shipping preference of the user; and a payment preference of the user.

In one embodiment, determining transaction information comprises communicating with a merchant data server that provides transaction information.

In one embodiment, the transaction information comprises at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

In one embodiment, determining transaction information comprises applying rules that govern or control the ability of the user to request the transaction or the ability of the payment instrument or financial account to perform the transaction.

In one embodiment, generating payment information comprises querying a database for storing and maintaining payment information for mobile users to retrieve the payment information.

In one embodiment, generating payment information comprises generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

In one embodiment, sending transaction information and payment information to a payment network comprises: sending the transaction and payment information to the payment network directly; or sending the transaction and payment information to the payment network via a merchant data server.

In one embodiment, the ecommerce transaction is a card present transaction.

In one embodiment, the ecommerce transaction is a card not present transaction.

In one embodiment, the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

In one embodiment, determining transaction information comprises getting user final approval to perform the transaction and/or authenticating the user.

In one embodiment, authenticating the user by the mobile device comprises receiving, at the mobile device, identification information for identifying the user and authentication information for authenticating the identity of the user and using the authentication information to authenticate the identity of the user.

In one embodiment, the information for identifying or authenticating the identity of the user comprises at least one of: a name of the user; an address of the user; an identification number associated with the user; biometric information provided by the user; a password, passcode, or personal information number (PIN) of the user; a digital signature of the user, a geo-location of the user, or information from the user's social network.

In one embodiment, authentication of the identity of the user is performed by the mobile device.

In one embodiment, the backend mobile server receives from the mobile device identification information and authentication information and uses the received information to authenticate the user.

In one embodiment, the identification or authentication information is provided by the user or by entity different from the user.

According to another embodiment of the subject matter described herein, a method for performing an advertisement-based electronic transaction using a mobile device comprises: at a mobile device associated with a user, receiving, from an advertisement available to the mobile device, first information about an item or transaction; and sending, to a mobile backend server for storing and maintaining payment information for mobile users, the first information and second information about the user; and, at the mobile backend server: processing the first and second information to determine transaction information and to generate payment information for an ecommerce transaction; and sending the transaction information and payment information to a payment network for processing the ecommerce transaction.

In one embodiment, receiving the first information comprises scanning, by the mobile device, text or an image that contains the first information in encoded form and decoding the text or image to extract the first information.

In one embodiment, receiving the first information comprises receiving the first information via an email, via a text message, via a multimedia message, or via an application hosted by the mobile device.

In one embodiment, receiving the first information comprises selecting text or an image being displayed on the mobile device, the text or image containing the first information in encoded form, and decoding the text or image to extract the first information.

In one embodiment, receiving the first information comprises selecting, by a computing device other than the mobile device, text or an image being displayed the computing device other than the mobile device, the text or image containing the first information in encoded form, and decoding the text or image to extract the first information.

In one embodiment, the text or image comprises a QR code image or bar code image.

In one embodiment, the text or image comprises a text image and wherein decoding the image comprises performing optical character recognition on the text image to extract the first information.

In one embodiment, receiving the first information comprises receiving or recording an audio sample that is presented or played from an advertisement and that contains the first information encoded as sound and decoding the audio sample to extract the first information.

In one embodiment, receiving the first information comprises receiving the first information via a wireless signal through a wireless interaction with a device that makes the advertisement available to the mobile device.

In one embodiment, receiving the first information via a wireless signal through a wireless interaction with the device that makes the advertisement available to the mobile device comprises at least one of: communicating using a near field communication (NFC) protocol; communicating using a radio frequency (RF) protocol; receiving the first information from a radio frequency identifier (RFID) chip; and communicating using an infrared (IR) communication protocol.

In one embodiment, the first information comprises at least one of: information that directly identifies the item or transaction; information that indirectly identifies the item or transaction; and information that indicates a source from which information about the item or transaction may be received.

In one embodiment, sending second information about the user comprises sending at least one of: information that identifies the user; information that identifies the mobile device; a current location of the user or mobile device; a billing address of the user; a shipping address of the user; a shipping preference of the user; and a payment preference of the user.

In one embodiment, determining transaction information comprises communicating with a merchant data server that provides transaction information.

In one embodiment, the transaction information comprises at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

In one embodiment, determining transaction information comprises applying rules that govern or control the ability of the user to request the transaction or the ability of the payment instrument or financial account to perform the transaction.

In one embodiment, generating payment information comprises querying a database for storing and maintaining payment information for mobile users to retrieve the payment information.

In one embodiment, generating payment information comprises generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

In one embodiment, sending transaction information and payment information to a payment network comprises: sending the transaction and payment information to the payment network directly; or sending the transaction and payment information to the payment network via a merchant data server.

In one embodiment, the method further comprises processing the ecommerce transaction by the payment network.

In one embodiment, the method further comprises reporting the result of the ecommerce transaction back to at least one of mobile backend server, the mobile device, and the user.

In one embodiment, the ecommerce transaction is a card present transaction.

In one embodiment, the ecommerce transaction is a card not present transaction.

In one embodiment, the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

In one embodiment, determining transaction information comprises getting user final approval to perform the transaction and/or authenticating the user.

In one embodiment, authenticating the user by the mobile device comprises receiving, at the mobile device, identification information for identifying the user and authentication information for authenticating the identity of the user and using the authentication information to authenticate the identity of the user.

In one embodiment, the information for identifying or authenticating the identity of the user comprises at least one of: a name of the user; an address of the user; an identification number associated with the user; biometric information provided by the user; a password, passcode, or personal information number (PIN) of the user; a digital signature of the user, a geo-location of the user, or information from the user's social network.

In one embodiment, authentication of the identity of the user is performed by the mobile device.

In one embodiment, the method further comprises, at the backend mobile server, receiving from the mobile device identification information and authentication information and using the received information to authenticate the user.

In one embodiment, the identification or authentication information is provided by the user or by entity different from the user.

According to another aspect of the subject matter described herein, a method for performing an advertisement-based electronic transaction without the involvement of a point of sale terminal or an ecommerce website comprises: at a mobile backend server for storing user information including payment information, receiving, from an electronic device of a user, first information for identifying the user and second information for identifying an item or transaction; using the first information to identify the user and generating payment information for the identified user; using the second information to identify a merchant data server that provides item or transaction information, communicating with the identified merchant data server to identify the item or transaction and to receive third information about the identified item or transaction, and communicating the third information about the identified item or transaction to the user; and, upon receiving an instruction from the user, sending the transaction information and payment information to a payment network for processing an electronic transaction.

As used herein, the term “Point Of Sale (POS) terminal” refers to a merchant- or seller- owned or controlled device that a user interacts with in order to perform a payment or non-payment transaction. Typical POS terminals include cash registers and credit card readers. The term “ecommerce website” refers to a merchant- or seller-controlled entity that provides an ecommerce portal to the user wherein the user can select items, add them to a checkout list or virtual shopping cart, and initiate a purchase which is handled by the ecommerce website.

In one embodiment, the first information comprises at least one of: information that directly or indirectly identifies the user; information that directly or indirectly identifies the electronic device; a geographic location of the user or electronic device; a network address of the electronic device; a billing address of the user; a shipping address of the user; and a payment preference of the user.

In one embodiment, the second information comprises information that directly or indirectly identifies the item or transaction.

In one embodiment, the second information comprises information that identifies a location of item or transaction information within a database for storing item or transaction information.

In one embodiment, receiving the second information comprises receiving a graphic element via an email, via a text message, via a multimedia message, or via an application hosted by the electronic device.

In one embodiment, receiving the second information comprises scanning, by the electronic device, a graphic element that contains the second information in encoded form, decoding the graphic element to extract the second information, and sending the second information to the mobile backend server.

In one embodiment, receiving the second information comprises selecting, via a display associated with the electronic device, a graphic element that contains the second information in encoded form, decoding the graphic element to extract the second information, and sending the second information to the mobile backend server.

In one embodiment, receiving the second information comprises selecting, via a display associated with the electronic device, a graphic element that, when selected, causes the mobile backend server to instruct the electronic device to activate an application hosted by the electronic device that provides the second information.

In one embodiment, the graphic element comprises at least one of: text, a QR code, a barcode, an image, and an image with data steganographically encoded within the image.

In one embodiment, receiving the second information comprises receiving the second information via a wireless signal through a wireless interaction between the electronic device and a second device that makes the advertisement available to the electronic device.

In one embodiment, receiving the second information via a wireless signal through a wireless interaction with the second device that makes the advertisement available to the mobile device comprises at least one of: communicating using a near field communication (NFC) protocol; communicating using a radio frequency (RF) protocol; communicating using an infrared (IR) communication protocol; and receiving the second information from a radio frequency identifier (RFID) chip.

In one embodiment, receiving the second information comprises, at the electronic device, receiving or recording an audio sample that is presented or played from the advertisement and that contains the second information encoded as sound, decoding the audio sample to extract the second information, and sending the second information to the mobile backend server.

In one embodiment, communicating the third information about the identified item or transaction comprises interacting with the user for at least one of: selecting item options; selecting payment options; selecting shipment options; selecting incentives; redeeming rewards; authenticating the user; and authorizing the transaction.

In one embodiment, the electronic device comprises a mobile device.

In one embodiment, the electronic device comprises a computer and wherein communicating the third information about the identified item or transaction comprises identifying a mobile device of the user, establishing a communication with the identified mobile device, and interacting with the mobile device.

In one embodiment, interacting with the mobile device comprises using the mobile device for at least one of: selecting item options; selecting payment options; selecting shipment options; selecting incentives; redeeming rewards; authenticating the user; and authorizing the transaction.

In one embodiment, sending the transaction and payment information to the payment network comprises sending the transaction and payment information to the payment network via a merchant data server.

According to yet another embodiment of the subject matter described herein, a system for performing an advertisement-based electronic transaction without the involvement of a point of sale terminal or an ecommerce website comprises: a database for storing and maintaining payment information for mobile users; and a mobile backend server for storing user information including payment information, wherein the mobile backend server is configured for: receiving, from an electronic device of a user, first information for identifying the user and second information for identifying an item or transaction; using the first information to identify the user and generating payment information for the identified user; using the second information to identify a merchant data server that provides item or transaction information, communicating with the identified merchant data server to identify the item or transaction and to receive third information about the identified item or transaction, and communicating the third information about the identified item or transaction to the user; and, upon receiving an instruction from the user, sending the transaction information and payment information to a payment network for processing an electronic transaction.

In one embodiment, the first information comprises at least one of: information that directly or indirectly identifies the user; information that directly or indirectly identifies the electronic device; a geographic location of the user or electronic device; a network address of the electronic device; a billing address of the user; a shipping address of the user; and a payment preference of the user.

In one embodiment, the second information comprises information that directly or indirectly identifies the item or transaction.

In one embodiment, the second information comprises information that identifies a location of item or transaction information within a database for storing item or transaction information.

In one embodiment, receiving the second information comprises receiving a graphic element via an email, via a text message, via a multimedia message, or via an application hosted by the electronic device.

In one embodiment, receiving the second information comprises scanning, by the electronic device, a graphic element that contains the second information in encoded form, decoding the graphic element to extract the second information, and sending the second information to the mobile backend server.

In one embodiment, receiving the second information comprises selecting, via a display associated with the electronic device, a graphic element that contains the second information in encoded form, decoding the graphic element to extract the second information, and sending the second information to the mobile backend server.

In one embodiment, the graphic element comprises at least one of: text, a QR code, a barcode, an image, and an image with data steganographically encoded within the image.

In one embodiment, receiving the second information comprises receiving the second information via a wireless signal through a wireless interaction between the electronic device and a second device that makes the advertisement available to the electronic device.

In one embodiment, receiving the second information via a wireless signal through a wireless interaction with the second device that makes the advertisement available to the mobile device comprises at least one of: communicating using a near field communication (NFC) protocol; communicating using a radio frequency (RF) protocol; communicating using an infrared (IR) communication protocol; and receiving the second information from a radio frequency identifier (RFID) chip.

In one embodiment, receiving the second information comprises, at the electronic device, receiving or recording an audio sample that is presented or played from the advertisement and that contains the second information encoded as sound, decoding the audio sample to extract the second information, and sending the second information to the mobile backend server.

In one embodiment, communicating the third information about the identified item or transaction comprises interacting with the user for at least one of: selecting item options; selecting payment options; selecting shipment options; selecting incentives; redeeming rewards; authenticating the user; and authorizing the transaction.

In one embodiment, the electronic device comprises a mobile device.

In one embodiment, the electronic device comprises a computer and wherein communicating the third information about the identified item or transaction comprises identifying a mobile device of the user, establishing a communication with the identified mobile device, and interacting with the mobile device.

In one embodiment, interacting with the mobile device comprises using the mobile device for at least one of: selecting item options; selecting payment options; selecting shipment options; selecting incentives; redeeming rewards; authenticating the user; and authorizing the transaction.

In one embodiment, sending the transaction and payment information to the payment network comprises sending the transaction and payment information to the payment network via a merchant data server.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for performing an advertisement-based electronic transaction using a mobile device according to an embodiment of the subject matter described herein;

FIG. 2 is a flow chart illustrating an exemplary process for performing an advertisement-based electronic transaction using a mobile device according to an embodiment of the subject matter described herein;

FIG. 3 is signal messaging diagram illustrating messages communicated among components of an exemplary system for performing an advertisement-based electronic transaction using a mobile device according to an embodiment of the subject matter described herein;

FIG. 4 is signal messaging diagram illustrating messages communicated among components of an exemplary system for performing an advertisement-based electronic transaction using a mobile device according to an embodiment of the subject matter described herein;

FIG. 5 is signal messaging diagram illustrating messages communicated among components of an exemplary system for performing an advertisement-based electronic transaction using a mobile device according to an embodiment of the subject matter described herein;

FIG. 6 is a block diagram illustrating an exemplary system for performing an advertisement-based electronic transaction using a mobile device according to another embodiment of the subject matter described herein;

FIG. 7 is signal messaging diagram illustrating messages communicated among components of an exemplary system for performing an advertisement-based electronic transaction using a mobile device according to an embodiment of the subject matter described herein;

FIG. 8 is a block diagram illustrating a mobile backend server according to an embodiment of the subject matter described herein;

FIG. 9 is a block diagram illustrating a mobile device according to an embodiment of the subject matter described herein; and

FIG. 10 is a flow chart illustrating an exemplary process for performing an advertisement-based electronic transaction using a mobile device according to another embodiment of the subject matter described herein.

### DETAILED DESCRIPTION

Methods and systems for performing an advertisement-based electronic transaction using a mobile device are provided herein. Unlike a so-called “mobile commerce” or “M-commerce” transaction, in which a mobile device is used in place of a personal computer to connect to a web-based ecommerce site, an advertisement-based electronic transaction takes place between a mobile device and a payment network without requiring any of conventional intervening entities, such as POS terminals or ecommerce websites, using information about the item or transaction received by the mobile device from an advertisement available to the mobile device. For example, information about the item or transaction may be received from an advertisement that is displayed or presented by an entity other than the mobile device and that is scanned or otherwise captured by the mobile device, or from an advertisement that is displayed on or presented by the mobile device itself, where the mobile device detects, extracts, or otherwise captures information so displayed or presented.

In one embodiment, the mobile device scans a QR code, from which it extracts enough information to engage in an ecommerce transaction directly with a payment network. Both CP and CNP transactions can be supported. Examples of other information sources include, but are not limited to: bar codes, which the mobile device can scan; NFC beacons, which transmit data that the mobile device can receive; images of text, which the mobile device can capture and on which it can perform optical character recognition (OCR).

The information received can include, but is not limited to, information about the item, information about transaction, and information about the merchant or provider. Such information may include, but is not limited to, the item name, description, Stock-Keeping Unit (SKU) number, or other type of description; the item price; the merchant, seller, or provider of the item; the location of the physical item being sold, the service being provided, and/or the point of purchase; the date and time of the transaction; and any other type of information.

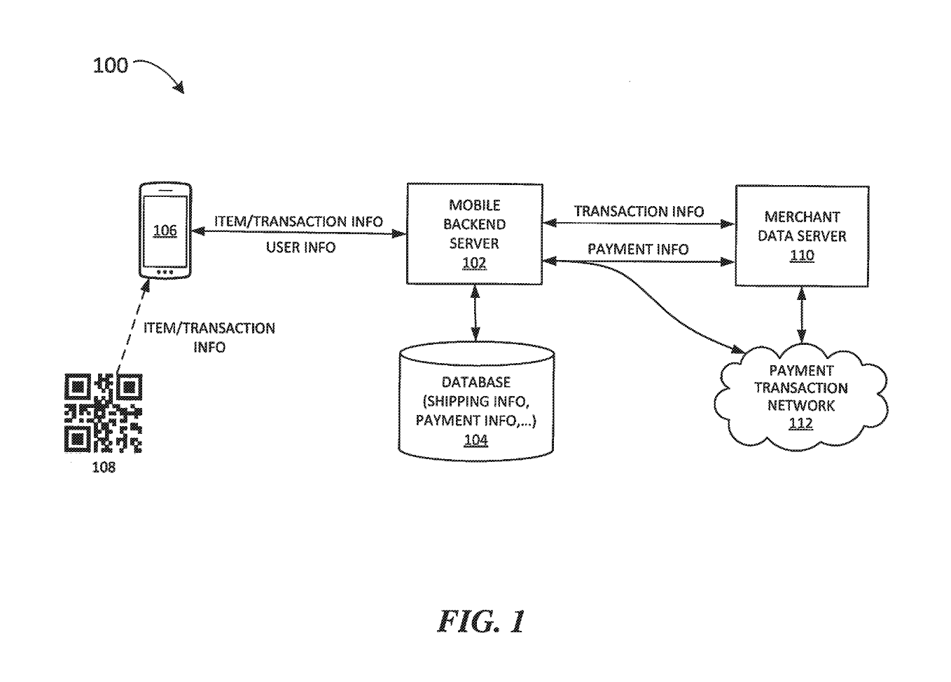

FIG. 1 is a block diagram illustrating an exemplary system for performing an advertisement-based electronic transaction using a mobile device according to an embodiment of the subject matter described herein. In the embodiment illustrated in FIG. 1, system 100 comprises a mobile backend server (MBS) 102 that communicates with a database 104 database for storing and maintaining payment information for mobile users.

The MBS 102 receives, from a mobile device 106 of a user, information that identifies an item of interest that is the subject of a desired ecommerce transaction (herein referred to as “item information”). MBS 102 may also receive information about the user (herein referred to as “user information”). The MB S 102 may use the user information to query database 104 to retrieve payment information that is ultimately sent to an entity that performs an ecommerce transaction. In the embodiment illustrated in FIG. 1, that entity is a payment transaction network 108, but other ecommerce transaction entities are also contemplated, including those that perform non-payment ecommerce transactions.

In one embodiment, the item information is provided by a merchant or other provider of goods or services. In the embodiment illustrated in FIG. 1, system 100 also comprises a merchant data server (MDS) 110, which is typically owned or operated by the merchant / provider and which may act as intermediary between the MBS 102 and payment transaction network 108. The merchant data server 110 may also be referred to as a manufacturer data server, a seller data server, a distributor data server, and so on. It is noted that the MDS 110 is not a traditional ecommerce server, in that it typically does not contain the functionality required to provide a web interface, maintain a shopping cart, process payments, or other functions performed by ecommerce servers. The MDS 110 may be thought of as a database server—an electronic catalog of sorts. This allows the MDS 110 to have very streamlined functionality. The functions of the components of system 100 will be described in more detail below.

In the embodiment illustrated in FIG. 1, the information is presented in the form of a QR code 112 that is displayed within an advertisement 114 that is available to mobile device 106. In the embodiment illustrated in FIG. 1, advertisement 114 is being displayed to the user via a display terminal 116, e.g., as the user is browsing the web. In this scenario, mobile device 106 may receive the data by scanning the QR code with its camera. In another embodiment, advertisement 114 may be being displayed on mobile device 106 directly. In this scenario, mobile device 106 may detect that there is a QR code being displayed on its own screen and extract the QR code directly.

User information may include, but is not limited to, information that identifies the user seeking the transaction, whether or not the user owns mobile device 106 (e.g., in case the user is using a friend's mobile device); information that identifies the mobile device itself; the current location of the user or mobile device; a billing address of the user; a shipping address of the user; a shipping preference of the user; a payment preference of the user; and so on.

Payment information may include, but is not limited to, information that is provided by a traditional magnetic stripe card or smart payment cards, such as primary account number, cardholder name, account holder name, expiration date, CSC data, the name of the issuing bank, billing address, shipping address, etc. In one embodiment, the payment information is tokenized, in which case the payment information may be a token that contains encoded payment information or that contains information that may be redeemed to determine payment information.

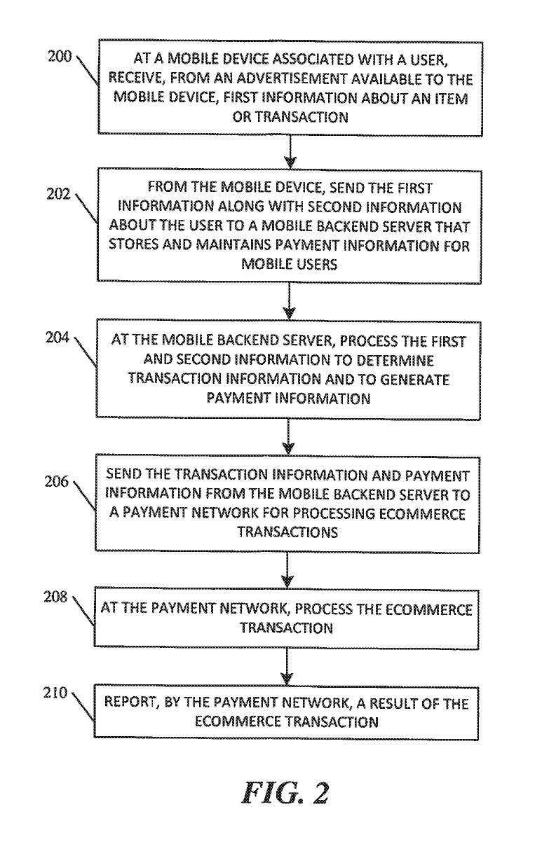

FIG. 2 is a flow chart illustrating an exemplary process for performing an advertisement-based electronic transaction using a mobile device according to another embodiment of the subject matter described herein. In the embodiment illustrated in FIG. 2, the method comprises the following steps, which will be described in reference to the example system 100 in FIG. 1.

At step 200, a mobile device associated with a user receives first information about an item or transaction from an advertisement available to the mobile device. In the embodiment illustrated in FIG. 1, for example, the mobile device 106 may scan the QR code 112 that is displayed within an advertisement 114 displayed to the user via a web browser, for example. The QR code comprises information about an item that the user may want to purchase and have delivered to his or her home.

At step 202, the mobile device sends the first information along with second information about the user to a mobile backend server that stores and maintains payment information for mobile users. In the embodiment illustrated in FIG. 1, for example, the mobile device 106 sends item information and user information to the MBS 102.

At step 204, the mobile backend server processes the first and second information to determine transaction information and to generate payment information. In the embodiment illustrated in FIG. 1, for example, MBS 102 may communicate with MDS 110 to determine transaction information, such as cost of goods including tax and shipping, etc. MBS 102 may use the user information received from mobile device 106 to query database 104 to get payment information.

At step 206, the mobile backend server sends transaction information and payment information to a payment network for processing the ecommerce transaction. In the embodiment illustrated in FIG. 1, for example, MBS 102 may send payment information to payment transaction network 108 directly or via MDS 110.

At step 208, the payment network processes the ecommerce transaction. In the embodiment illustrated in FIG. 1, for example, payment transaction network 108 may perform a card present or card not present ecommerce transaction.

At step 210, the payment network reports the result(s) of the ecommerce transaction. In the embodiment illustrated in FIG. 1, for example, payment transaction network 108 may report whether the ecommerce transaction passed or failed. This report or notification may be sent to mobile device 106, to MBS 102, and/or to MDS 110.

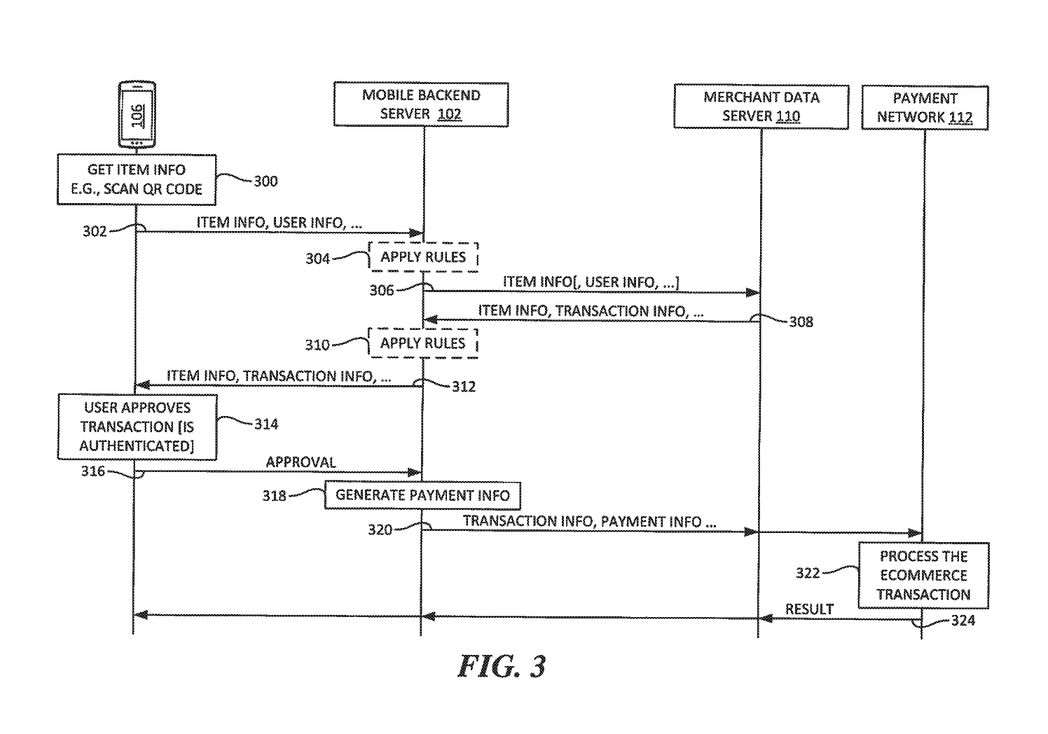

An example operation of system 100 will now be described in more detail using FIG. 3. It will be understood that the phrase “information that identifies <X>” may refer to information that directly identifies the object X, such as the name of a person, the address of a building, the description of an item, etc., and may refer to information that indirectly identifies the object X, such as a key or search term that may be used to identify an entry in a database that contains information about the object, for example.

FIG. 3 is a signal messaging diagram illustrating messages communicated among components of an exemplary system for performing an advertisement-based electronic transaction using a mobile device according to an embodiment of the subject matter described herein. In the embodiment illustrated in FIG. 3, at block 300, a user of a mobile device 106 gets information about an item. The item of interest may be a product, such as an item on a shelf, an item displayed in an advertisement or print catalog, kiosk, or screen, etc. The item of interest may be a service, such as a manicure, a membership in a health club, a year of lawn care, etc. The item of interest may be a transaction, such as a money transfer, a stock purchase, etc. The item of interest may be, but is not limited to, anything which may be the subject of or related to an ecommerce transaction.

In one example scenario, a user may be presented with an advertisement that offers the user with an opportunity to purchase an airplane ticket. Once the user has entered the travel information and selected dates and times for the flight(s), the advertisement may display a QR code, which the user scans with mobile device 106. The QR code may include any type of item information. The item information may be received by mobile device 106 via other means, including, but not limited to, transmission via near-field communication (NFC) or other wireless protocol, such as Wi-Fi, WiMAX, 802.11, cellular, infrared (IR), audio, video, still image, manual entry, bar codes, or other available methods.

In one embodiment, once mobile device 106 has received the item information, mobile device 106 sends the item information to a MBS 102 (message 302). In the embodiment illustrated in FIG. 3, mobile device 106 also comprises user information in message 302.

MBS 102 receives the information and prepares to initiate an ecommerce transaction. In one embodiment, MBS 102 may apply a set of rules that control whether or not a particular transaction should be allowed, based on which user is requesting the transaction, based on what products or services are involved in the transaction, based on whether transaction limits have been exceeded, and so on. These are described in more detail in the '883 provisional mentioned above. In the embodiment illustrated in FIG. 3, at block 304, MBS 102 may apply rules right away to make sure that the item is one that the user is allowed to purchase. For example, an underage user of mobile device 106 may be prohibited from purchasing alcohol. In this scenario, the application of rules at block 304 may result in MBS 102 denying the attempted transaction, in which case the process would stop there. In the embodiment illustrated in FIG. 3, it is assumed that the application of the rules did not result in the transaction being blocked. Rules may be applied by MBS 102 at any point during the process. Likewise, in one embodiment, MBS 102 may not be configured to support or apply any rules.

If the application of rules in block 304 does not result in denial of the transaction (or if block 304 is not performed, i.e., there is no rules check at this point in the process), MBS 102 may use the item information to identify an MDS 110 which is associated with the merchant or entity that is offering the item for sale or providing the desired service. In this scenario, MBS 102 may communicate with the identified MDS 110 (message 306), e.g., to verify that the item or service is available for purchase and/or delivery. In one embodiment, message 306 may include user information as well, which allows MDS 110 to use the user's shipping address or shipping preference to determine shipping costs, to offer discounts or additional deals to the user, and so on. In response, MDS 110 may provide to MBS 102 additional item information and/or transaction information (message 308).

Additional item information may include, but is not limited to, confirmation that the item is available, a list of available colors, styles, and/or sizes (e.g., in the case of clothing or footwear), proposed substituted goods or services (e.g., if the desired good or service is unavailable), additional items that the user may want to consider, etc.

Transaction information may include, but is not limited to, the total cost of the item, including tax and/or shipping, an estimated delivery date, the source of the goods or provider of the services, and so on.

In one embodiment, MBS 102 may apply rules to determine whether the transaction should (still) be allowed or otherwise control the behavior of the payment instrument (block 310). In the example illustrated in FIG. 3, the transaction has not been blocked, and therefore MBS 102 sends the item information and transaction information (message 312) to mobile device 106, which may display that information to the user for final approval of the transaction (block 314). In one embodiment, mobile device 106 may require user authentication, such as the entry of a password, pass phrase, PIN, or biometric verification, before or at the same time that the user indicates approval of the transaction at block 314.

In one embodiment, the item and transaction information 312 may indicate to the user that the user has received a discount. For example, the user may be presented with the discounted price, which may be shown as an absolute price, a relative price compared with the undiscounted price (shown as a relative number, relative percentage, or both, for example), or some combination of the above.

In the scenario illustrated in FIG. 3, the user approves the transaction. Mobile device 106 sends notification of that approval to MBS 102 (message 316). Once approval is received, MBS 102 may generate payment information (block 318). In one embodiment, MBS 102 may query database 104 to retrieve the payment information associated with the user of mobile device 106. In one embodiment, MBS 102 may have previously authenticated the combination of mobile user and payment information (or some combination of mobile user, mobile device, and payment information, for example). This payment information may be selected based on the user's preference or other user info and may be constrained or modified by the application of other rules.

In the embodiment illustrated in FIG. 3, MBS 102 may then forward at least some of the payment information along with the transaction information to a payment network 112 (message 320), which processes the ecommerce transaction (block 322) and reports the result of the transaction (message 324) back to the MDS 110, to the MBS 102, and/or to the mobile device 106 (and by extension to the user of the mobile device). In one embodiment, message 320 is sent directly to payment network 112. In an alternative embodiment, message 320 is sent to payment network 112 via MDS 110.

In one embodiment, the ecommerce transaction may be processed as a CP transaction or as a CNP transaction, depending on what information payment network 112 receives from MBS 102. For example, if the payment information generated at block 318 comprises a CSC1 value, payment network 112 may process the payment as a CP transaction. Alternatively, if the payment information comprises a CSC2 value (or no CSC but a billing address instead), payment network 112 may process the payment as a CNP transaction.

The sequences of messages and actions illustrated in FIG. 3 are illustrative and not limiting. Other embodiments are also within the scope of the subject matter described herein. For example, in one alternative embodiment, MBS 102 may skip the rule application steps 304 and 310 entirely, and may instead apply no rules at all or apply rules at other points in the process.

In another alternative embodiment, the interaction between MBS 102 and MDS 110, represented by messages 306 and 308, may occur at a different time in the process or may be skipped entirely.

In yet another alternative embodiment, steps 312, 314, and 316 may be skipped entirely, i.e., user final approval of the transaction is not sought.

In one embodiment, the functions of MBS 102 may be integrated with the functions of MDS 110. In these embodiments, system 100 may contain one or the other of MBS 102 and MDS 110, but not both. In the embodiment illustrated in FIG. 1, MBS 102 and MDS 110 are shown as distinct entities. They may be logically or physically distinct/separate from each other.

In one embodiment, one or more backend servers (e.g., 102 and/or 110) may receive the item information and user information and calculate the transaction information, including using the user information to determine which, if any, discounts are available to the user, e.g., based on the user's choice of payment instrument, the user's membership in a rewards club, and so on.

In an alternative embodiment, some or all of this determination may be performed by mobile device 106. For example, an application running on mobile device 106 may send a request to one of the backend servers to provide a list of discounts that might be available for the product or service that is the subject of the electronic transaction. Rental car companies, for example, may offer a discounted rate to consumers who are over a certain age, to consumers who are members of a particular professional organization, to consumers who use a particular bank card, to consumers who have a particular type of auto insurance, and so on. Mobile device 106 may request and receive such a list, and then use that list to determine which discount or combination of discounts is the most financially attractive and notify the backend server(s) that the particular discount or combination of discounts is to be applied to the transaction. Likewise, other distributions of labor and/or decision-making are contemplated.

In another embodiment, mobile device 106 may notify the user that he or she qualifies a discount and prompts the user to decide whether or not to take the discount. Likewise, the user may be notified that multiple discounts are available and may be prompted to select one of the discounts (if mutually exclusive) or to select multiple discounts (if not mutually exclusive). In another embodiment, the user of mobile device 106 may be presented with a dynamically updated price or transaction cost that changes based on multiple criteria, which may include, but is not limited to, the selections that the user makes during the completion of the transaction.

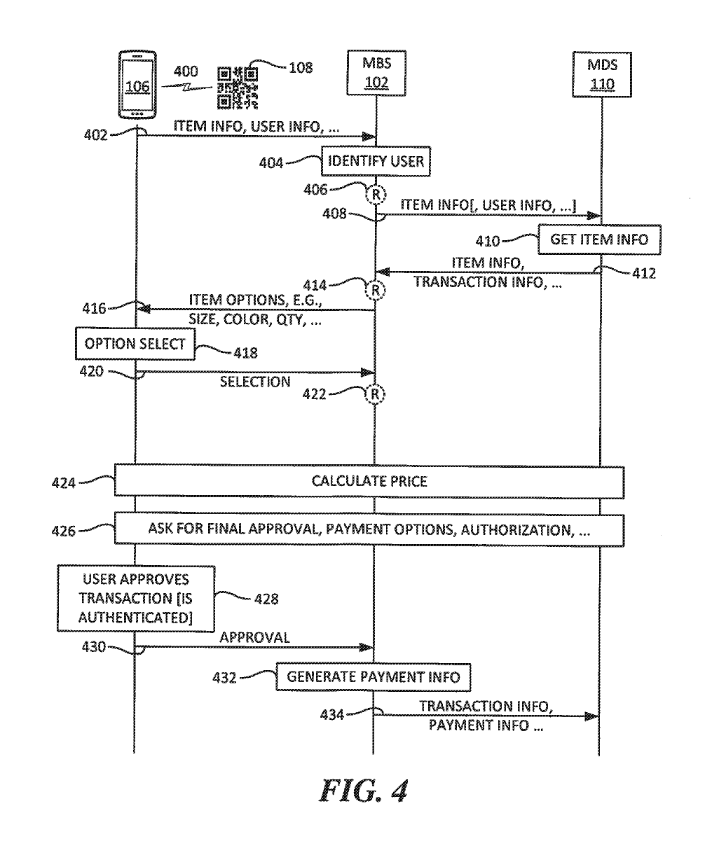

FIG. 4 is signal messaging diagram illustrating messages communicated among components of an exemplary system for performing an advertisement-based electronic transaction using a mobile device according to an embodiment of the subject matter described herein. In the embodiment illustrated in FIG. 4, a user may use his or her mobile device 106 to receive information about an item and/or transaction (referred to herein as “first information”). In one embodiment, this may occur when the mobile device 106 scans a QR code 108, shown as data transfer 400. This may be controlled by a mobile application running on the mobile device 106, which decodes the QR code to extract from it the first information. The first information may directly or indirectly identify a good or service.

The mobile device 106 then conveys the first information along with second information that directly or indirectly identifies the user of the mobile device 106 to a MBS (MBS) 102. This is shown as message 402. In one embodiment, the mobile application is configured to know how to identify and connect to MBS 102, in which case the QR code 108 need not and does not include information for that purpose.

At block 404, upon receipt of the first information and second information, the MBS 102 uses some or all of the second information to identify the user. The MBS 102 may then collect additional information about the user, e.g., from a database, such as database 104 in FIG. 1, which it may use for later steps of the process. Examples of such information include, but are not limited to, user name, user address, user purchase history, user preferences including but not limited to preferred payment instrument, preferred shipping method, etc., spending limits, budget limits, and other types of information.

In one embodiment, MBS 102 may be configured to apply rules at one or more points in the process. Example rules include limitations on the transaction amount, limitations on the type of goods or service or item-related limitations, and so on. This is represented as a dotted circle containing the letter “R”, such as element 406 shown in FIG. 4. Other opportunities to apply such rules will be described below.

In the embodiment illustrated in FIG. 4, the first information may, along with optional user information, be sent by the MBS 102 to a merchant's MDS 110 (shown as message 408). The first information may identify an item directly, or the first information may be used to indirectly identify an item. For example, the first information may be a Universal Product Code (UPC), which the MDS 110 maps to a SKU number, or other information.

At block 410, the MDS 110 uses the received information to get item information. Examples of item information include, but are not limited to, price, description, availability, and zero or more options, including but not limited to color, pattern, style, size, length, width, height, or other options. In some scenarios, the user information may affect the content of the item information determined by the MDS 110. For example, a rewards club member may get a better price, have access to stock that is in limited supply, and so on. Other types of information may include, for items that are physically stored in a warehouse and will be shipped to the user upon completion of the transaction, the locations and distance to various warehouses as well as indications whether or not the item in question is available at each warehouse. This type of information may be considered item information, transaction information, or a hybrid.

The item information is then provided from the MDS 110 to the MBS 102 (arrow 412). Here again, rules may be applied (circle 414). For example, the user may be a child who is using a parent's account to purchase goods, in which case rules 414 may apply to allow or deny the particular transaction. In another example, rules 414 may operate to prevent a minor from purchasing alcohol. Other types of rules may be applied here.

One aspect of the subject matter illustrated in FIG. 4 is the ability to notify the prospective purchaser when there are options associated with the subject of the transaction. In one example use case, a user may see an advertisement for a coat. The user may take a picture of the coat using his or her mobile device. The advertisement may include first information about the item encoded as a QR code, steganographic information, and so on, which the mobile app decodes and sends via the MBS 102 to the MDS 110. The MDS 110 may determine that the item in question comes in only a few sizes or colors, and provides this information about available sizes and colors to the MBS 102, which then presents the options to the user (message 416), who can then make one or more selections (block 418). The selection information is conveyed (message 420) back to the MBS 102, which may again apply rules (circle 422).

After one or more items are scanned and options selected, then the price of the item may be calculated and optionally displayed to the user. Since this function could be performed at the mobile device 106, at the MBS 102, at the MDS 110, or some combination of the above, this is represented in FIG. 4 by block 424. This may be repeated after each item is processed (e.g., after each QR code is scanned), or it may be performed only after the user indicates that the item selection process is complete.

In the embodiment illustrated in FIG. 4, at block 426, the user is asked for final approval of the transaction. At this time, the user may select or indicate a desired payment instrument, may select or indicate desired payment options, and may also be authorized. Once the user approves the transaction (block 428), the mobile device 106 sends an indication of such approval (message 430) to the MBS 102, which then generates payment information (credit card information, etc.) to be sent (message 434) to the MDS 110. The MDS may then initiate the transaction with a payment network.

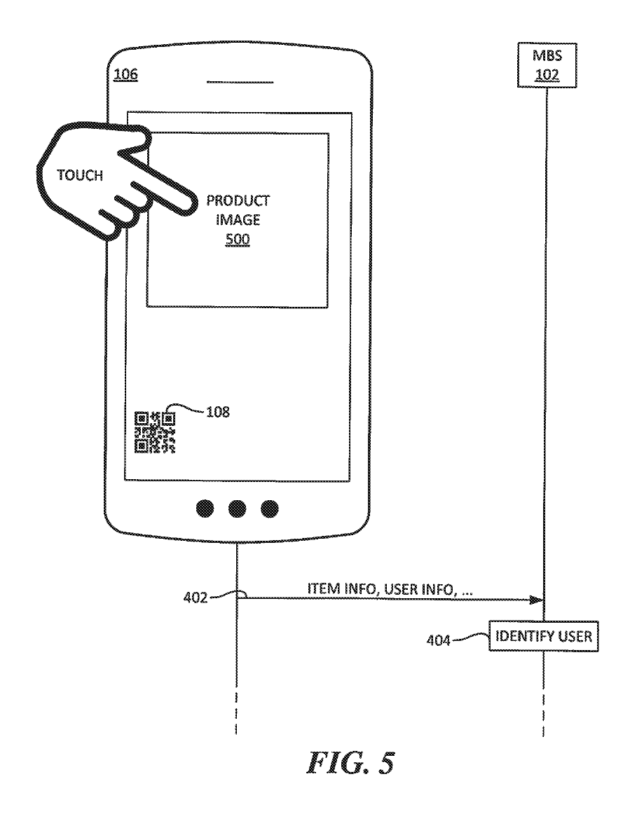

FIG. 5 is signal messaging diagram illustrating messages communicated among components of an exemplary system for performing an advertisement-based electronic transaction using a mobile device according to an embodiment of the subject matter described herein. In the embodiment illustrated in FIG. 5, the user is using his or her mobile device 106 to view a product. In one embodiment, the product image itself contains information about the product steganographically encoded within the image; when the user touches the product image, the mobile application detects and decodes the steganographically-encoded data to get the first information, which is sent to the MBS 102, e.g., using the same process as steps 402, 404, and so on, in FIG. 4. Alternatively, the user may touch a QR code 108, a bar code, text, or other element being displayed on the screen of the mobile device 106, which triggers the mobile application to extract the first information and send the first information to the MBS 102.

It is noted particularly that the product image and QR code being displayed does not need to be part of an ecommerce website. The information within the image, QR code, etc., is used to identify the item or transaction, and does not include any payment information, does not include any user information, and does not include any account information. The user information may be provided by the mobile application, the payment information may be provided by the MBS 102, and the account information may be provided by the MBS 102, the MDS 110, or both. This has several benefits: first, it allows the first information to be very sparse; second, it allows the first information to be displayed essentially anywhere; third, it allows the user to perform a transaction without using a POS terminal or an ecommerce website.

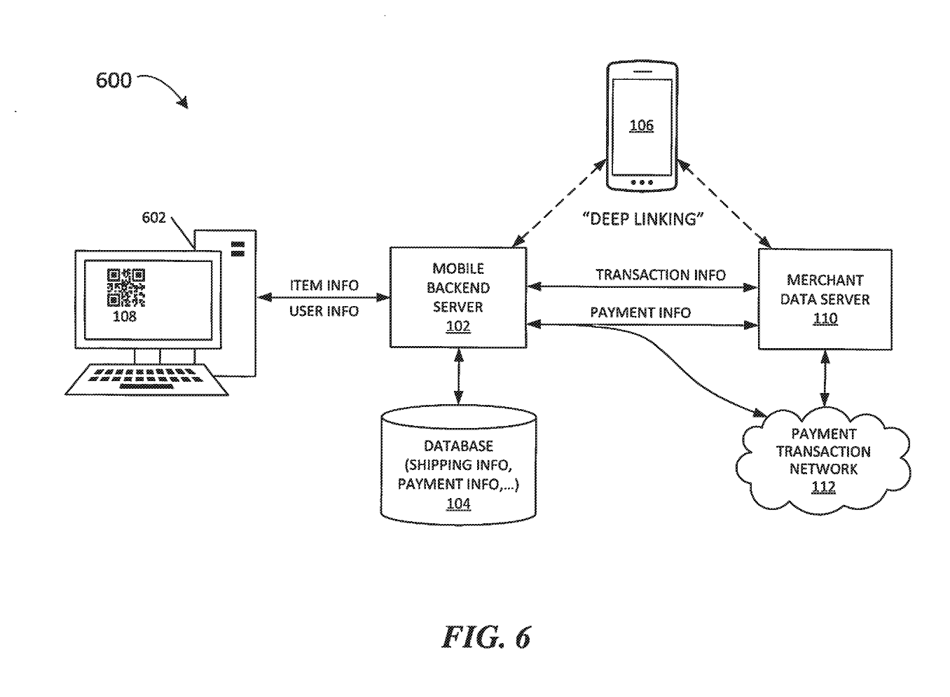

FIG. 6 is a block diagram illustrating an exemplary system for performing an advertisement-based electronic transaction using a mobile device according to another embodiment of the subject matter described herein. In the embodiment illustrated in FIG. 6, system 600 comprises an MBS 102, a database 104, a mobile device 106, an MDS 110, and a payment transaction network 112, which are essentially the same as the like-numbered elements of FIG. 1 and therefore their descriptions will not be repeated here. In the embodiment illustrated in FIG. 6, a user is using a computer 602 upon which an advertisement, such as QR code 108, an image, etc., is displayed in an application, such as a web browser or a custom application. In one example, when the user clicks the QR code 108, the application connects to the MBS 102 and passes first information and user information to the MBS 102. In one embodiment, the QR code 108, image, or other, is a link to a URL that represents the MBS 102, and clicking on the link causes the computer 602 to issue an HTTP PUT or GET that comprises parameters that identify the item or service being advertised, along with information from which the user may be directly or indirectly identified. From that point, either the MBS 102 or the MDS 110 may perform “deep linking”, i.e., establishing a connection to a mobile device 106 that is associated with the user that clicked on the link. Once the connection to the mobile device 106 is established, the steps starting from 304 in FIG. 3 or starting from 404 in FIG. 4 may proceed as shown in those figures, respectively, i.e., using the mobile device 106 in place of the computer 602. The linking may occur at the application level or at the operating system level. In one embodiment, for example, the user of a personal computer 602, his or her own mobile device 106, his or her own tablet or portable computer, or even a device owned by a merchant or person other than the user, may click on a QR code 108, text, an image, or other graphical element being displayed, which causes the MBS 102 to send a command or other message to the mobile device 106, which in turn causes the mobile device 106 to start an application that displays information about the item or transaction. The mobile device 106 may then provide that second information to the MBS 102 or the MBS 102 may already have access to the second information before activating the application on the user's mobile device 106.

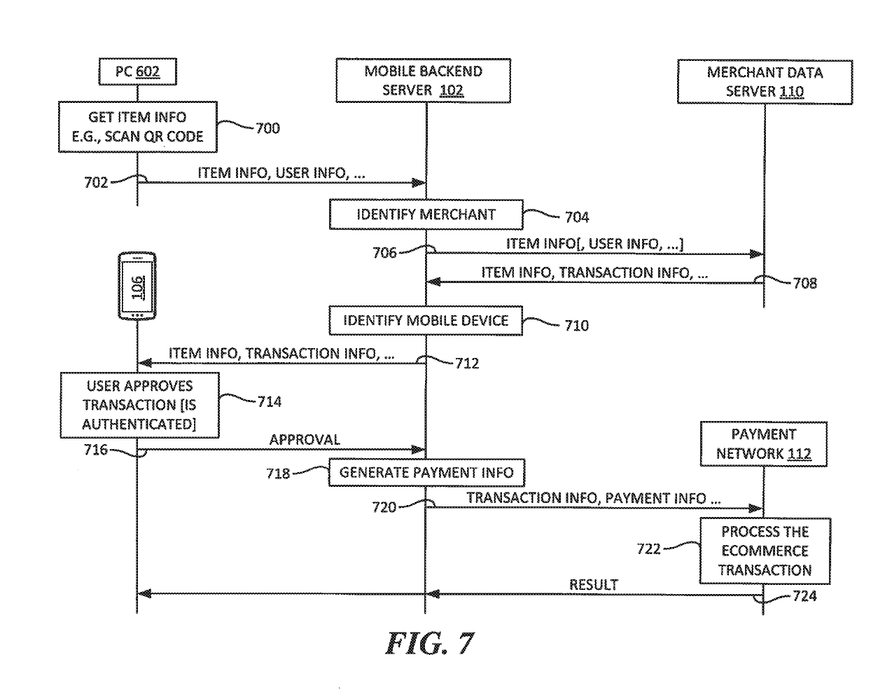

FIG. 7 is signal messaging diagram illustrating messages communicated among components of an exemplary system for performing an advertisement-based electronic transaction using a mobile device according to an embodiment of the subject matter described herein. In the embodiment illustrated in FIG. 7, at block 700, a user using a personal computer (PC) 602 or other electronic device that is NOT the user's mobile phone 106, gets information about an item or transaction (referred to generically as “item info”). This information and user information are both communicated to a MBS 102 (message 702).

The MBS 102 uses the item information to identify a merchant (block 704). The MBS 102 identifies an MDS 110 that provides data for that merchant's products and communicates with that MDS 110 (messages 706 and 708) to retrieve item information and perhaps transaction information as well. The MBS 102 also identifies a mobile device of the user (block 710) and establishes communication with that mobile device.

In the embodiment illustrated in FIG. 7, the MBS 102 then sends the item and transaction information (message 712) to the identified mobile device 106, so that the user may, for example, make item selections, such as size, color, quantity, and so on, as well as select a payment option (or make no selection, in which case the default payment for that user will be used by the MBS 102), select coupons or other incentives to be applied, until the user ultimately decides whether to approve the transaction or not (block 714). The mobile device 106 may also authenticate the user.

If the user approves (message 716), the MBS 102 generates transaction / payment information (block 718), which is then sent to the payment network 112 (message 720). The payment network 112 processes the ecommerce transaction (block 722) and reports the result (message 724).

In the embodiment illustrated in FIG. 7, the MBS 102 communicates directly with the payment network 112 to perform the ecommerce transaction, but in alternative embodiments, the MBS 102 may send this information via the MDS 110 or another network entity which handles transaction-related activities, such as fulfillment, coupon reconciliation, rewards / points updates, and so on.

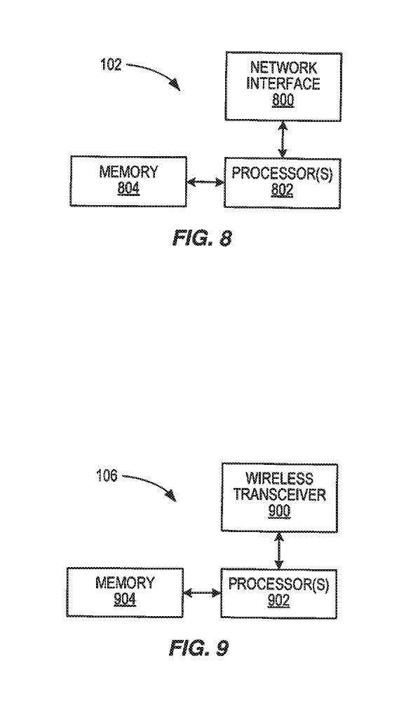

FIG. 8 is a block diagram illustrating a mobile backend server 102 according to an embodiment of the subject matter described herein. In the embodiment illustrated in FIG. 8, MBS 102 includes a network interface 800 for communicating with a telecommunication network, one or more processors 802, and memory 804 for storing instructions executable by one or more of the processors 802. The MBS 102 is operable to receive, from an electronic device of a user, first information for identifying the user and second information for identifying an item or transaction; use the first information to identify the user and generating payment information for the identified user; use the second information to identify a merchant data server that provides item or transaction information, communicate with the identified merchant data server to identify the item or transaction and to receive third information about the identified item or transaction, and communicate the third information about the identified item or transaction to the user; and, upon receiving an instruction from the user, send the transaction information and payment information to a payment network for processing an electronic transaction.

FIG. 9 is a block diagram illustrating a mobile device 106 according to an embodiment of the subject matter described herein. In the embodiment illustrated in FIG. 9, mobile device 106 includes a wireless transceiver 900 for communicating with a wireless network, one or more processors 902, and memory 904 for storing instructions executable by the one or more processors 902. The mobile device 106 is operable to receive, from an advertisement available to the mobile device, first information about an item or transaction, and send, to a mobile backend server for storing and maintaining payment information for mobile users, the first information and second information about the user.

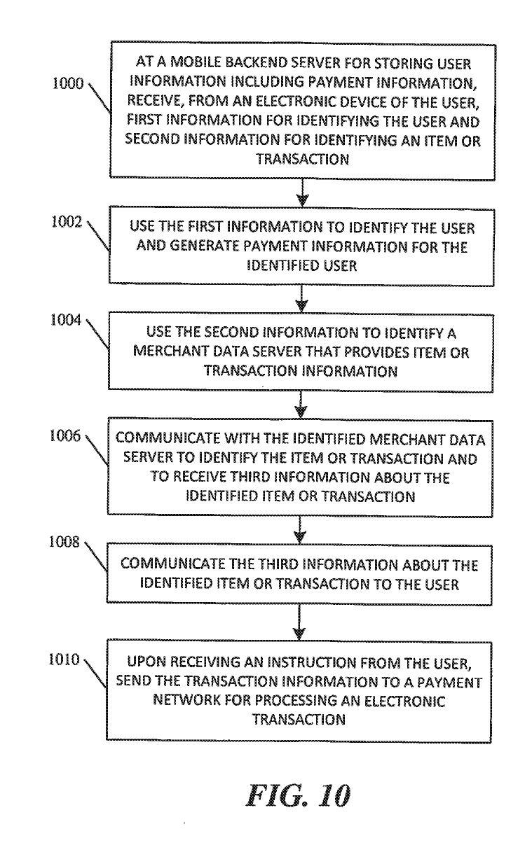

FIG. 10 is a flow chart illustrating an exemplary process for performing an advertisement-based electronic transaction using a mobile device according to another embodiment of the subject matter described herein. In the embodiment illustrated in FIG. 10, the method comprises the following steps:

At step 1000, a mobile backend server for storing user information including payment information, receives, from an electronic device of a user, first information for identifying the user and second information for identifying an item or transaction.

At step 1002, the mobile backend server uses the first information to identify the user and generate payment information for the identified user.

At step 1004, the mobile backend server uses the second information to identify a merchant data server that provides item or transaction information.

At step 1006, the mobile backend server communicates with the identified merchant data server to identify the item or transaction and to receive third information about the identified item or transaction. Examples of third information includes, but is not limited to, price, specifications, options, available colors, sizes, or styles, available quantity in stock, unit and bulk pricing, available discounts, coupons, or incentives associated with the item or transaction, shipping options, and so on.

At step 1008, the mobile backend server communicates the third information about the identified item or transaction to the user. For example, this information may be sent to the user via the user's mobile device. The user may use this information to select options, choose quantities, or make other decisions.

At step 1010, upon receiving an instruction from the user (e.g., the user indicates a desire to make a purchase), the mobile backend server sends the transaction information to a payment network for processing an electronic transaction.

The concept of performing an advertisement-based electronic transaction has a wide range of applications, including, but not limited to, the following examples and use cases.

Physical (so-called “brick and mortar”) stores with a wide variety of products but limited space sometimes have “virtual aisles”, which may be kiosks or other display areas, that display products for which there is no space in the physical store. A shopper who sees an item of interest displayed on the virtual aisle can use his or her mobile device to scan a QR code that is displayed with or otherwise associated with the image of the item of interest. The mobile device can decode the QR code to extract information about the item or transaction and use the extracted information to perform an ecommerce transaction directly with a payment network. In one embodiment, the ecommerce transaction may include shipping and delivery of the purchased good right to the buyer's home, office, or other location from the warehouse. In one embodiment, a store may display a copy of the most current sales catalog, flyer, or mailer showing goods or services on sale.

The QR code or other information can be displayed via a wide variety of advertising media, including, but not limited to, being printed on a surface and being displayed on visual display, such as a dynamic advertisement display.

The MBS can perform additional functions, including, but not limited to, providing a discount to a user based on the user's profile, membership in a rewards or loyalty program, use of promotional codes, shipping preferences, etc. The MBS may apply rules that limit what kind of ecommerce transactions are available to the user, the device, the payment instrument to be used, or some combination of the above. For example, a child may scan a QR code to purchase a product but the MBS may block that purchase unless the purchase is authorized by an administrator (e.g., unless the parent allows it). In this scenario, the parent may get a notification on his or her mobile phone that a child is attempting a purchase, and the ecommerce transaction is not allowed unless the parent authorizes that transaction.

### Embodiments

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

Embodiment 1: A system for performing an advertisement-based electronic transaction using a mobile device, the system comprising: a database for storing and maintaining payment information for mobile users; and a mobile backend server that receives, from a mobile device of a user, first information about an item or transaction, wherein the mobile device received the first information from an advertisement available to the mobile device, and second information about the user, that processes the first and second information to determine transaction information and to generate payment information, and that sends the transaction and payment information to a payment network for processing the ecommerce transaction.

Embodiment 2: The system of embodiment 1 wherein receiving the first information includes scanning an advertisement having an image that contains the first information in encoded form and decoding the image to extract the first information.

Embodiment 3: The system of embodiment 2 wherein the image comprises a QR code image or bar code image.

Embodiment 4: The system of embodiment 2 wherein the image comprises a text image and wherein decoding the image comprises performing optical character recognition on the text image to extract the first information.

Embodiment 5: The system of embodiment 1 wherein receiving the first information includes receiving or recording an audio sample that is presented or played from an advertisement and that contains the first information encoded as sound and decoding the audio sample to extract the first information.

Embodiment 6: The system of embodiment 1 wherein receiving the first information includes receiving the first information via a wireless signal produced by a device that makes the advertisement available to the mobile device.

Embodiment 7: The system of embodiment 6 wherein receiving the first information via a wireless signal produced by the device that makes the advertisement available to the mobile device includes at least one of: communicating using a near field communication (NFC) protocol; receiving the first information from a radio frequency identifier (RFID) chip; and communicating using an infrared (IR) communication protocol.

Embodiment 8: The system of embodiment 1 wherein sending second information about the user includes sending at least one of: information that identifies the user; information that identifies the mobile device; a current location of the user or mobile device; a billing address of the user; a shipping address of the user; a shipping preference of the user; and a payment preference of the user.

Embodiment 9: The system of embodiment 1 wherein determining transaction information includes communicating with a merchant data server that provides transaction information.

Embodiment 10: The system of embodiment 1 wherein the transaction information includes at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

Embodiment 11: The system of embodiment 1 wherein determining transaction information includes applying rules that govern or control the ability of the user to request the transaction or the ability of the payment instrument or financial account to perform the transaction.

Embodiment 12: The system of embodiment 1 wherein generating payment information includes querying a database for storing and maintaining payment information for mobile users to retrieve the payment information.

Embodiment 13: The system of embodiment 1 wherein generating payment information includes generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

Embodiment 14: The system of embodiment 1 wherein sending transaction information and payment information to a payment network includes: sending the transaction and payment information to the payment network directly; or sending the transaction and payment information to the payment network via a merchant data server.

Embodiment 15: The system of embodiment 1 comprising processing the ecommerce transaction by the payment network.

Embodiment 16: The system of embodiment 15 comprising reporting the result of the ecommerce transaction back to at least one of mobile backend server, the mobile device, and the user.

Embodiment 17: The system of embodiment 1 wherein the ecommerce transaction is a card present transaction.

Embodiment 18: The system of embodiment 1 wherein the ecommerce transaction is a card not present transaction.

Embodiment 19: The system of embodiment 1 wherein the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

Embodiment 20: The system of embodiment 1 wherein determining transaction information includes getting user final approval to perform the transaction and/or authenticating the user.

Embodiment 21: The system of embodiment 20 wherein authenticating the user by the mobile device includes receiving, at the mobile device, identification information for identifying the user and authentication information for authenticating the identity of the user and using the authentication information to authenticate the identity of the user.

Embodiment 22: The system of embodiment 21 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

Embodiment 23: The system of embodiment 21 wherein authentication of the identity of the user is performed by the mobile device.

Embodiment 24: The system of embodiment 21 comprising, at the backend mobile server, receiving from the mobile device identification information and authentication information and using the received information to authenticate the user.

Embodiment 25: The system of embodiment 21 wherein the identification or authentication information is provided by the user or by entity different from the user.

Embodiment 26: A method for performing an advertisement-based electronic transaction using a mobile device, the method comprising: at a mobile device associated with a user: receiving, from an advertisement available to the mobile device, first information about an item or transaction; and sending, to a mobile backend server for storing and maintaining payment information for mobile users, the first information and second information about the user; at the mobile backend server: processing the first and second information to determine transaction information and to generate payment information for an ecommerce transaction; and sending the transaction information and payment information to a payment network for processing the ecommerce transaction.

Embodiment 27: The method of embodiment 26 wherein receiving the first information includes scanning an advertisement having an image that contains the first information in encoded form and decoding the image to extract the first information.

Embodiment 28: The method of embodiment 27 wherein the image comprises a QR code image or bar code image.

Embodiment 29: The method of embodiment 27 wherein the image comprises a text image and wherein decoding the image comprises performing optical character recognition on the text image to extract the first information.

Embodiment 30: The method of embodiment 26 wherein receiving the first information includes receiving or recording an audio sample that is presented or played from an advertisement and that contains the first information encoded as sound and decoding the audio sample to extract the first information.

Embodiment 31: The method of embodiment 26 wherein receiving the first information includes receiving the first information via a wireless signal produced by a device that makes the advertisement available to the mobile device.

Embodiment 32: The method of embodiment 31 wherein receiving the first information via a wireless signal produced by the device that makes the advertisement available to the mobile device includes at least one of: communicating using a near field communication (NFC) protocol; receiving the first information from a radio frequency identifier (RFID) chip; and communicating using an infrared (IR) communication protocol.

Embodiment 33: The method of embodiment 26 wherein sending second information about the user includes sending at least one of: information that identifies the user; information that identifies the mobile device; a current location of the user or mobile device; a billing address of the user; a shipping address of the user; a shipping preference of the user; and a payment preference of the user.

Embodiment 34: The method of embodiment 26 wherein determining transaction information includes communicating with a merchant data server that provides transaction information.

Embodiment 35: The method of embodiment 26 wherein the transaction information includes at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

Embodiment 36: The method of embodiment 26 wherein determining transaction information includes applying rules that govern or control the ability of the user to request the transaction or the ability of the payment instrument or financial account to perform the transaction.

Embodiment 37: The method of embodiment 26 wherein generating payment information includes querying a database for storing and maintaining payment information for mobile users to retrieve the payment information.

Embodiment 38: The method of embodiment 26 wherein generating payment information includes generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

Embodiment 39: The method of embodiment 26 wherein sending transaction information and payment information to a payment network includes: sending the transaction and payment information to the payment network directly; or sending the transaction and payment information to the payment network via a merchant data server.

Embodiment 40: The method of embodiment 26 comprising processing the ecommerce transaction by the payment network.

Embodiment 41: The method of embodiment 40 comprising reporting the result of the ecommerce transaction back to at least one of mobile backend server, the mobile device, and the user.

Embodiment 42: The method of embodiment 26 wherein the ecommerce transaction is a card present transaction.

Embodiment 43: The method of embodiment 26 wherein the ecommerce transaction is a card not present transaction.

Embodiment 44: The method of embodiment 26 wherein the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

Embodiment 45: The method of embodiment 26 wherein determining transaction information includes getting user final approval to perform the transaction and/or authenticating the user.

Embodiment 46: The method of embodiment 45 wherein authenticating the user by the mobile device includes receiving, at the mobile device, identification information for identifying the user and authentication information for authenticating the identity of the user and using the authentication information to authenticate the identity of the user.

Embodiment 47: The method of embodiment 46 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

Embodiment 48: The method of embodiment 46 wherein authentication of the identity of the user is performed by the mobile device.

Embodiment 49: The method of embodiment 46 comprising, at the backend mobile server, receiving from the mobile device identification information and authentication information and using the received information to authenticate the user.

Embodiment 50: The method of embodiment 46 wherein the identification or authentication information is provided by the user or by entity different from the user.

Embodiment 51: A non-transitory computer readable medium having stored thereon executable instructions that when executed by the processor of a computer control the computer to perform steps comprising: at a mobile device associated with a user: receiving, from an advertisement available to the mobile device, first information about an item or transaction; and sending, to a mobile backend server for storing and maintaining payment information for mobile users, the first information and second information about the user; at the mobile backend server: processing the first and second information to determine transaction information and to generate payment information for an ecommerce transaction; and sending the transaction information and payment information to a payment network for processing the ecommerce transaction.

Embodiment 52: A mobile backend server for performing an advertisement-based electronic transaction without the involvement of a point of sale terminal or an ecommerce website, the mobile backend server comprising: a database for storing user information including payment information; one or more processors; and memory storing instructions executable by the one or more processors, whereby the mobile backend server is operable to: receive, from a first electronic device of a user, first information for identifying an item and second information for identifying the user; use the first information to identify the item and to determine information associated with the item; use the second information to identify the user and to determine information associated with a transaction; generate third information comprising the information associated with the item and the information associated with the transaction; and send the third information to an electronic device for presentation to and approval by the user, the electronic device comprising the first electronic device of the user or a second electronic device of the user different from the first electronic device of the user, wherein the mobile backend server generates and sends the third information to the electronic device without involvement of a point of sale terminal or an ecommerce website.

Embodiment 53: The mobile backend server of embodiment 52 being further operable to receive, from the electronic device, approval of the third information, and, in response to receiving the approval, initiate an electronic transaction for the item without the involvement of a point of sale terminal or an ecommerce website.

Embodiment 54: The mobile backend server of embodiment 53 wherein initiating the electronic transaction for the item comprises initiating the electronic transaction directly with a payment transaction network.

Embodiment 55: The mobile backend server of embodiment 52 wherein receiving the first and second information from a first electronic device of a user comprises receiving the first and second information from a mobile device of the user.

Embodiment 56: The mobile backend server of embodiment 52 wherein the first information for identifying an item comprises information for identifying a product, service, and/or transaction.

Embodiment 57: The mobile backend server of embodiment 52 wherein the first information for identifying an item comprises information that directly or indirectly identifies the item.

Embodiment 58: The mobile backend server of embodiment 52 wherein the second information for identifying the user comprises: information that identifies the user; information that identifies the electronic device of the user; and/or a current location of the user or the electronic device of the user.

Embodiment 59: The mobile backend server of embodiment 52 wherein the information associated with the item comprises a name of the item, a description of the item, a Stock Keeping Unit (SKU) number of the item, a quantity of the item, and/or a price of the item.

Embodiment 60: The mobile backend server of embodiment 52 wherein the information associated with the item reflects a user preference regarding an aspect of the item.

Embodiment 61: The mobile backend server of embodiment 60 wherein the user preference regarding an aspect of the item comprises a user preference with regard to at least one of size, color and style.

Embodiment 62: The mobile backend server of embodiment 52 wherein the information associated with the transaction comprises a payment method or payment instrument of the user, a payment preference of the user, a billing address of the user, a shipping address of the user, a shipping preference of the user, an email address of the user, and/or a telephone number of the user.

Embodiment 63: The mobile backend server of embodiment 62 wherein the shipping preference of the user comprises a preference to deliver the item to a particular location, wherein the particular location comprises the user's home, the user's office, or another location specified by the user.

Embodiment 64: The mobile backend server of embodiment 52 wherein at least some of third information was previously stored on the mobile backend server.

Embodiment 65: The mobile backend server of embodiment 52 wherein at least some of third information is received by the mobile backend server from an entity other than the electronic device of the user.

Embodiment 66: The mobile backend server of embodiment 52 wherein the first information or the second information was generated by a first application and wherein the third information is configured by the mobile backend server to be displayed by the first application or by a second application different from the first application.

Embodiment 67: The mobile backend server of embodiment 66 wherein the first application comprises a browser application or a non-browser application.3

Embodiment 68: The mobile backend server of embodiment 52 wherein the third information comprises a product information page.

Embodiment 69: The mobile backend server of embodiment 68 wherein the product information page comprises a graphic element which, when selected or activated by the user, will trigger the mobile backend server to initiate an electronic transaction for the item without the involvement of a point of sale terminal or an ecommerce website.

Embodiment 70: The mobile backend server of embodiment 52 wherein, upon determining that at least some of the third information is unavailable to the mobile backend server, the method further comprise, prior to the generating and sending steps: requesting the user to provide the unavailable information; receiving, from the user, the provided information; and including the provided information in the third information.

Embodiment 71: The mobile backend server of embodiment 53 being further operable to authenticate the user prior to initiating the electronic transaction for the item without the involvement of a point of sale terminal or an ecommerce website.

Embodiment 72: The mobile backend server of embodiment 71 being operable to authenticate the user using authentication information provided by the electronic device of the user, information provided by the user by a means other than the electronic device of the user, and information provided by a third party.

Embodiment 73: The mobile backend server of embodiment 71 wherein the authentication information comprises at least one of: a name of the user; an address of the user; an identification number associated with the user; biometric information provided by the user; a password, passcode, or personal information number (PIN) of the user; a digital signature of the user; a geo-location of the user; and information from the user's social network.

Embodiment 74: An electronic device of a user for performing an advertisement-based electronic transaction without the involvement of a point of sale terminal or an ecommerce website, the electronic device comprising: one or more processors; and memory storing instructions executable by the one or more processors, whereby the electronic device is operable to: display, within an application hosted on the electronic device, an advertisement for an item of interest; detect an indication of the user's interest in the advertisement; send, to a mobile backend server, first information for identifying an item and second information for identifying the user; receive, from the mobile backend server, third information comprising information associated with the item and information associated with the transaction; display to the user and within the application, the third information.

Embodiment 75: The electronic device of embodiment 74 wherein the application hosted on the electronic device comprises a web browser, a social media page, a social media application, a messaging application, an email application, a retailer application, a banking application, an enterprise application, a manufacturer application, or a service application.

Embodiment 76: The electronic device of embodiment 74 wherein displaying the advertisement comprises displaying visual, aural, or haptic information representing the item of interest.

Embodiment 77: The electronic device of embodiment 74 wherein displaying the advertisement comprises displaying information that identifies the seller.

Embodiment 78: The electronic device of embodiment 74 wherein detecting an indication of the user's interest in the advertisement comprises detecting that the user clicked on, touched, or selected the advertisement.

Embodiment 79: The electronic device of embodiment 74 wherein the first information for identifying an item comprises information for identifying a product, service, and/or transaction.

Embodiment 80: The electronic device of embodiment 74 wherein the first information for identifying an item comprises information that directly or indirectly identifies the item.

Embodiment 81: The electronic device of embodiment 74 wherein the second information for identifying the user comprises information that identifies the user; information that identifies the electronic device; and/or a current location of the user or the electronic device.

Embodiment 82: The electronic device of embodiment 74 wherein the information associated with the item comprises a name of the item, a description of the item, a Stock Keeping Unit (SKU) number of the item, a quantity of the item, and/or a price of the item.

Embodiment 83: The electronic device of embodiment 74 wherein the third information comprises one or more payment instruments for the user to select for use in the transaction.

Embodiment 84: The electronic device of embodiment 83 wherein the electronic device is further operable to detect the selection of one of the one or more payment instruments by the user and use the selected payment instrument for the transaction.

Embodiment 85: The electronic device of embodiment 84 wherein the electronic device is further operable to store the selected payment instrument as the default payment instrument for subsequent transactions.

Embodiment 86: The electronic device of embodiment 85 wherein storing the selected payment instrument as the default payment instrument for subsequent transactions comprises storing the selected payment instrument within the electronic device of the user or within the mobile backend server.

Embodiment 87: The electronic device of embodiment 74 wherein the third information comprises a default payment instrument previously selected by the user.

Embodiment 88: The electronic device of embodiment 74 wherein the third information is customized according to a user preference by providing default values to be used unless changed by the user.

Embodiment 89: The electronic device of embodiment 74 wherein the information associated with the item reflects a user preference regarding an aspect of the item.

Embodiment 90: The electronic device of embodiment 89 wherein the user preference regarding an aspect of the item comprises a user preference with regard to at least one of size, color and style.

Embodiment 91: The electronic device of embodiment 74 wherein the information associated with the transaction comprises a payment method or payment instrument of the user, a payment preference of the user, a billing address of the user, a shipping address of the user, a shipping preference of the user, an email address of the user, and/or a telephone number of the user.

Embodiment 92: The electronic device of embodiment 91 wherein the shipping preference of the user comprises a preference to deliver the item to a particular location, wherein the particular location comprises the user's home, the user's office, or another location specified by the user.

Embodiment 93: The electronic device of embodiment 74 wherein the third information comprises a product information page.

Embodiment 94: The electronic device of embodiment 93 wherein the product information page comprises a graphic element which, when selected or activated by the user, will trigger the mobile backend server to initiate an electronic transaction for the item without the involvement of a point of sale terminal or an ecommerce website.

Embodiment 95: The electronic device of embodiment 74 wherein the electronic device is further operable to: detect an approval of the transaction by the user; and notify the mobile backend that the transaction was approved by the user.

Embodiment 96: The electronic device of embodiment 74 wherein the electronic device is further operable to: receive, from the mobile backend, a result of the transaction; and display the result of the transaction to the user.

Embodiment 97: The electronic device of embodiment 74 wherein the electronic device is further operable to authenticate the user.

What is claimed is:

1. A mobile backend server for performing an advertisement-based electronic transaction without the involvement of a point of sale terminal or an ecommerce website, the mobile backend server comprising:
a database for storing user information including payment information;
one or more processors; and
memory storing instructions executable by the one or more processors, whereby the mobile backend server is operable to:
receive, from a first electronic device of a user, first information for identifying an item and second information for identifying the user;
use the first information to identify the item and to determine information associated with the item;
use the second information to identify the user and to determine information associated with a transaction;
generate third information comprising the information associated with the item and the information associated with the transaction; and
send the third information to an electronic device for presentation to and approval by the user, the electronic device comprising the first electronic device of the user or a second electronic device of the user different from the first electronic device of the user,
wherein the mobile backend server generates and sends the third information to the electronic device without involvement of a point of sale terminal or an ecommerce website.

2. The mobile backend server of claim 1 being further operable to receive, from the electronic device, approval of the third information, and, in response to receiving the approval, initiate an electronic transaction for the item without the involvement of a point of sale terminal or an ecommerce website and directly or indirectly with a payment transaction network.

3. The mobile backend server of claim 1 wherein receiving the first and second information from a first electronic device of a user comprises receiving the first and second information from a mobile device of the user.

4. The mobile backend server of claim 1 wherein the first information for identifying an item comprises information that directly or indirectly identifies the item, the information comprising a product, service, and/or transaction.

5. The mobile backend server of claim 1 wherein the second information for identifying the user comprises: information that identifies the user; information that identifies the electronic device of the user; and/or a current location of the user or the electronic device of the user.

6. The mobile backend server of claim 1 wherein the information associated with the item comprises a name of the item, a description of the item, a Stock Keeping Unit (SKU) number of the item, a quantity of the item, and/or a price of the item and/or reflects a user preference regarding an aspect of the item, the user preference comprising a user preference with regard to at least one of size, color and style.

7. The mobile backend server of claim 1 wherein the information associated with the transaction comprises a payment method or payment instrument of the user, a payment preference of the user, a billing address of the user, a shipping address of the user, a shipping preference of the user, an email address of the user, and/or a telephone number of the user, the shipping preference comprisign a preference to deliver the item to a particular location, wherein the particular location comprises the user's home, the user's office, or another location specified by the user.

8. The mobile backend server of claim 1 wherein at least some of third information was previously stored on the mobile backend server, is received by the mobile backend server from an entity other than the electronic device of the user, and/or comprises a product information page comprising a graphic element which, when selected or activated by the user, will trigger the mobile backend server to initiate an electronic transaction for the item without the involvement of a point of sale terminal or an ecommerce website.

9. The mobile backend server of claim 1 wherein the first information or the second information was generated by a first application and wherein the third information is configured by the mobile backend server to be displayed by the first application or by a second application different from the first application, wherein the first application comprises a browser application or a non-browser application.

10. The mobile backend server of claim 1 wherein, upon determining that at least some of the third information is unavailable to the mobile backend server, the method further comprise, prior to the generating and sending steps:
requesting the user to provide the unavailable information;
receiving, from the user, the provided information; and
including the provided information in the third information.

11. The mobile backend server of claim 2 being further operable to authenticate the user prior to initiating the electronic transaction for the item without the involvement of a point of sale terminal or an ecommerce website.

12. The mobile backend server of claim 11 being operable to authenticate the user using authentication information provided by the electronic device of the user, information provided by the user by a means other than the electronic device of the user, and information provided by a third party, the authentication information comprising at least one of:
a name of the user;
an address of the user;
an identification number associated with the user;
biometric information provided by the user;
a password, passcode, or personal information number (PIN) of the user;
a digital signature of the user;
a geo-location of the user; and
information from the user's social network.

13. An electronic device of a user for performing an advertisement-based electronic transaction without the involvement of a point of sale terminal or an ecommerce website, the electronic device comprising:
one or more processors; and
memory storing instructions executable by the one or more processors, whereby the electronic device is operable to:
display, within an application hosted on the electronic device, an advertisement for an item of interest;
detect an indication of the user's interest in the advertisement;
send, to a mobile backend server, first information for identifying an item and second information for identifying the user;
receive, from the mobile backend server, third information comprising information associated with the item and information associated with the transaction;
display to the user and within the application, the third information.

14. The electronic device of claim 13 wherein the application hosted on the electronic device comprises a web browser, a social media page, a social media application, a messaging application, an email application, a retailer application, a banking application, an enterprise application, a manufacturer application, or a service application.

15. The electronic device of claim 13 wherein displaying the advertisement comprises displaying visual, aural, or haptic information representing the item of interest, and/or displaying information that identifies the seller.

16. The electronic device of claim 13 wherein detecting an indication of the user's interest in the advertisement comprises detecting that the user clicked on, touched, or selected the advertisement.

17. The electronic device of claim 13 wherein the first information for identifying an item comprises information for directly or indirectly identifying a product, service, and/or transaction, the information comprising a name of the item, a description of the item, a Stock Keeping Unit (SKU) number of the item, a quantity of the item, and/or a price of the item.

18. The electronic device of claim 13 wherein the second information for identifying the user comprises information that identifies the user; information that identifies the electronic device; and/or a current location of the user or the electronic device.

19. The electronic device of claim 13 wherein the third information comprises one or more payment instruments for the user to select for use in the transaction.

20. The electronic device of claim 19 wherein the electronic device is further operable to detect the selection of one of the one or more payment instruments by the user and use the selected payment instrument for the transaction and/or store the selected payment instrument as the default payment instrument for subsequent transactions, wherein storing the selected payment instrument as the default payment instrument for subsequent transactions comprises storing the selected payment instrument within the electronic device of the user or within the mobile backend server.

21. The electronic device of claim 13 wherein the third information comprises a default payment instrument previously selected by the user, is customized according to a user preference by providing default values to be used unless changed by the user, and/or reflects a user preference regarding an aspect of the item, the user preference comprising a user preference with regard to at least one of size, color and style.

22. The electronic device of claim 13 wherein the information associated with the transaction comprises a payment method or payment instrument of the user, a payment preference of the user, a billing address of the user, a shipping address of the user, a shipping preference of the user, an email address of the user, and/or a telephone number of the user, the shipping preference of the user comprising a preference to deliver the item to a particular location, wherein the particular location comprises the user's home, the user's office, or another location specified by the user.

23. The electronic device of claim 13 wherein the third information comprises a product information page copmrising a graphic element which, when selected or activated by the user, will trigger the mobile backend server to initiate an electronic transaction for the item without the involvement of a point of sale terminal or an ecommerce website.

24. The electronic device of claim 13 wherein the electronic device is further operable to: detect an approval of the transaction by the user, and notify the mobile backend that the transaction was approved by the user; receive, from the mobile backend, a result of the transaction and display the result of the transaction to the user; and/or authenticate the user.
